(19) United States
(12) Patent Application Publication
(10) Pub. No.: US 2024/0112347 A1
(43) Pub. Date: Apr. 4, 2024

(54) METHOD FOR DETECTING NESTED CLOSED SHAPES IN AN IMAGE

(71) Applicant: Konica Minolta Business Solutions U.S.A., Inc., San Mateo, CA (US)

(72) Inventor: Darrell Eugene Bellert, Boulder, CO (US)

(73) Assignee: Konica Minolta Business Solutions U.S.A., Inc., San Mateo, CA (US)

(21) Appl. No.: 17/958,090

(22) Filed: Sep. 30, 2022

(51) Int. Cl. G06T 7/13

(52) U.S. Cl. CPC G06T 7/13

(57) ABSTRACT

A nested closed shapes detection method includes detecting contours of an object in an image and obtaining pixel coordinates and hierarchy information of the contours; grouping, based on the hierarchy information, the contours into groups of sibling contours; for each of the groups, mending adjacent ones of the sibling contours separated by a gap equal to or less than a predetermined number of pixels; fitting a closed shape to each of the mended sibling contours and extending each of the mended sibling contours to mirror the closed shape; and building a hierarchy of nested closed shapes.

### BACKGROUND

Computer vision techniques capable of detecting nested closed shapes in an image can be used to obtain measurements of various object features for the purposes of inspection. For example, the obtained measurements can be compared against a specification of the object to determine if the object has been cast correctly.

Further, shape detection techniques of computer vision are used to transform raw image data into the symbolic representations needed for object recognition and location. For example, shape detection in computer vision using the Hough Transform is a conventional technique commonly used for the detection of closed shapes such as circles, ellipses, etc., within an image. However, Hough Transform techniques require complex or lengthy calculations, extended time for processing data, a large amount of storage, and costly computations. Other conventional techniques require making certain assumptions or sacrificing flexibility in the algorithm. These conventional techniques are generally slow and struggle to accurately detect nested closed shapes within an image.

### SUMMARY

In one aspect, a nested closed shapes detection method according to one or more embodiments includes: detecting contours of an object in an image and obtaining pixel coordinates and hierarchy information of the contours; grouping, based on the hierarchy information, the contours into groups of sibling contours; for each of the groups, mending adjacent ones of the sibling contours separated by a gap equal to or less than a predetermined number of pixels; fitting a closed shape to each of the mended sibling contours and extending each of the mended sibling contours to mirror the closed shape; and building a hierarchy of nested closed shapes.

In another aspect, a non-transitory computer readable medium (CRM) according to one or more embodiments stores computer readable instructions for nested closed shapes detection in an image. The computer readable instructions cause a computer to: detect contours of an object in an image and obtain pixel coordinates and hierarchy information of the contours; group, based on the hierarchy information, the contours into groups of sibling contours; for each of the groups, mend adjacent ones of the sibling contours separated by a gap equal to or less than a predetermined number of pixels; fit a closed shape to each of the mended sibling contours and extend each of the mended sibling contours to mirror the closed shape; and build a hierarchy of nested closed shapes.

### BRIEF DESCRIPTION OF DRAWINGS

FIG. 1 shows a flowchart for detecting nested closed shapes in an image of an object in accordance with one or more embodiments of the invention.

FIG. 2 shows a flowchart for detecting contours of the object in accordance with one or more embodiments of the invention.

FIG. 3 shows an illustration for grouping circular contours into groups of sibling contours for a circular object in accordance with one or more embodiments of the invention.

FIG. 4 shows a flowchart for mending adjacent sibling contours in accordance with one or more embodiments of the invention.

FIG. 5A and FIG. 5B, continued from FIG. 5A, show a flowchart for fitting the closed shape to each of the mended sibling contours and extending each of the mended sibling contours in accordance with one or more embodiments of the invention.

FIG. 6 shows a flowchart for building a hierarchy of nested closed shapes in accordance with one or more embodiments of the invention.

FIG. 7A shows an input image of an object in accordance with one or more embodiments of the invention. FIG. 7B shows an illustration of the input image shown in FIG. 7A.

FIG. 8A shows the input image converted to grayscale and filtered in accordance with one or more embodiments of the invention. FIG. 8B shows an illustration of the input image shown in FIG. 8A.

FIG. 9A shows the input image after edges detection was performed on the filtered grayscale image in accordance with one or more embodiments of the invention. FIG. 9B shows an illustration of the input image shown in FIG. 9A.

FIG. 10 shows an illustration of a mended sibling contour of the input image illustrated in FIGS. 7-9 in accordance with one or more embodiments of the invention.

FIG. 11 shows a flowchart for estimating a circle contour in accordance with one or more embodiments of the invention.

FIG. 12 shows a flowchart for finding two angular extrema points of a contour relative to the center of the estimated circle.

FIG. 13A shows an illustration of sibling contours and FIG. 13B shows a flowchart for selecting the best gluable candidate among the sibling contours shown in FIG. 13A in accordance with one or more embodiments of the invention.

FIG. 14 shows a flowchart for fitting a circle to a circle candidate in accordance with one or more embodiments of the invention.

FIG. 15 shows a flowchart for creating a list of extension candidates in accordance with one or more embodiments of the invention.

FIG. 16 shows an illustration of a circle candidate and extension candidates in accordance with one or more embodiments of the invention.

FIG. 17 shows an illustration of identifying a starting point and an ending point on the circle candidate's fitted circle in accordance with one or more embodiments of the invention.

FIG. 18 shows an illustration of identifying two inner and outer points for the starting point and the ending point on the circle candidate's fitted circle in accordance with one or more embodiments of the invention.

FIG. 19 shows an illustration of identifying a midway point on the fitted circle between the starting point and the ending point and identifying two inner and outer points for the midway point in accordance with one or more embodiments of the invention.

FIG. 20 shows an illustration of constructing an inner circle and an outer circle and identifying, as a set of candidate contours, all contours that are within the outer circle but outside of the inner circle in accordance with one or more embodiments of the invention.

FIG. 21 shows a computing system in accordance with one or more embodiments of the invention.

### DETAILED DESCRIPTION

Specific embodiments of the present invention will now be described in detail below with reference to the accompanying drawings. Like elements in the various figures are denoted by like reference numerals for consistency.

In the following detailed description of embodiments of the invention, numerous specific details are set forth to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third) may be used as an adjective for an element (e.g., any noun in the application). The use of ordinal numbers is not to imply or create a particular ordering of the elements nor to limit any element to being only a single element unless expressly disclosed, such as using the terms “before,” “after,” “single,” and other such terminology. Rather the use of ordinal numbers is to distinguish between the elements. By way of an example, a first element is distinct from a second element, and the first element may encompass more than one element and may succeed (or precede) the second element in an ordering of elements.

In general, embodiments of the invention provide a method, non-transitory computer readable medium (CRM), and system for detecting nested closed shapes from an input image. In one or more embodiments, contours of an object in an image are used as the basis for nested closed shapes detection. The contours of the object in the image are detected and the result of detecting the contours of the object in the image yields a list of pixel coordinates of all contours in the edges image along with hierarchy information about the contours (e.g., representation of the relationship between contours in an image). Using the hierarchy information about the contours, the contours are grouped together such that each contour in a sibling group shares the same parent contour (as used herein, a “parent contour” is the outer contour that contains therein one or more inner contours or “sibling contours”). For each of the groups of sibling contours, adjacent sibling contours separated by a gap equal to or less than a predetermined number of pixels (e.g., 5 pixels) are mended. After all close adjacent sibling contours (e.g., separated by 5 pixels or less) have been mended, each of the mended sibling contours is fitted to a closed shape and extended to mirror the closed shape. Then, after all the sibling contours have been mended, fitted to closed shapes, and extended to mirror the closed shapes across all the sibling groups, a hierarchy of nested closed shapes is built. Once the hierarchy of nested closed shapes is built, the nested closed shapes can be used to obtain measurements of various object features for the purposes of inspection. The measurements can be compared against a specification of the object to determine if the object has been cast correctly.

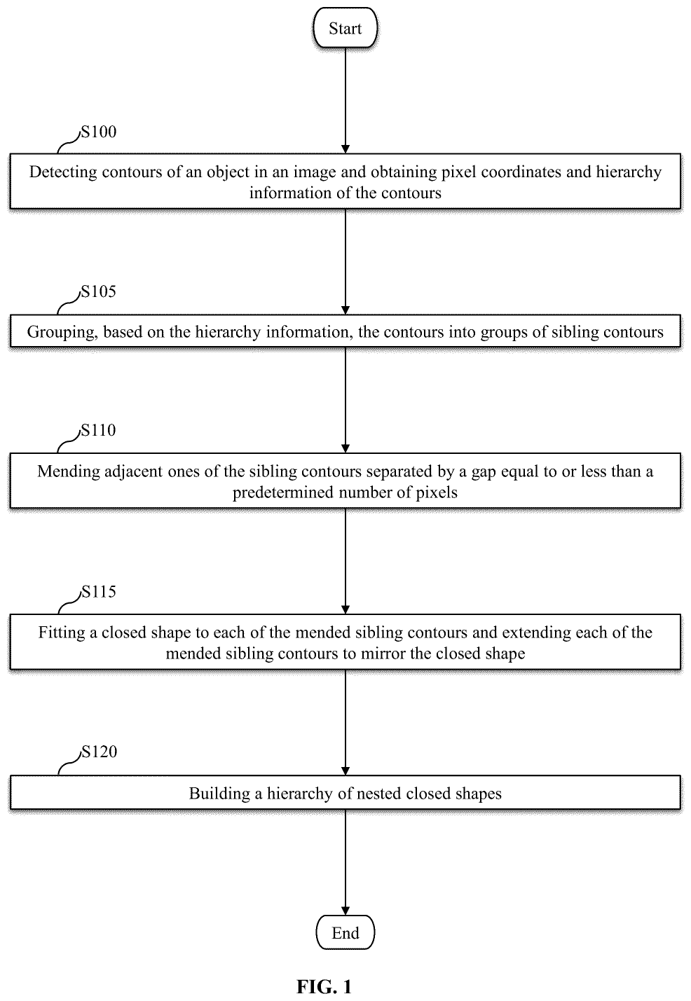

FIG. 1 shows a high-level flowchart of a method for detecting nested closed shapes in an image in accordance with one or more embodiments of the invention. In general, one or more of the steps of any of the flowcharts described herein may be combined, omitted, repeated, and/or performed in a different order than the order shown or described. Accordingly, the scope of the invention should not be considered limited to the specific arrangement of steps shown in any of the flowcharts described herein.

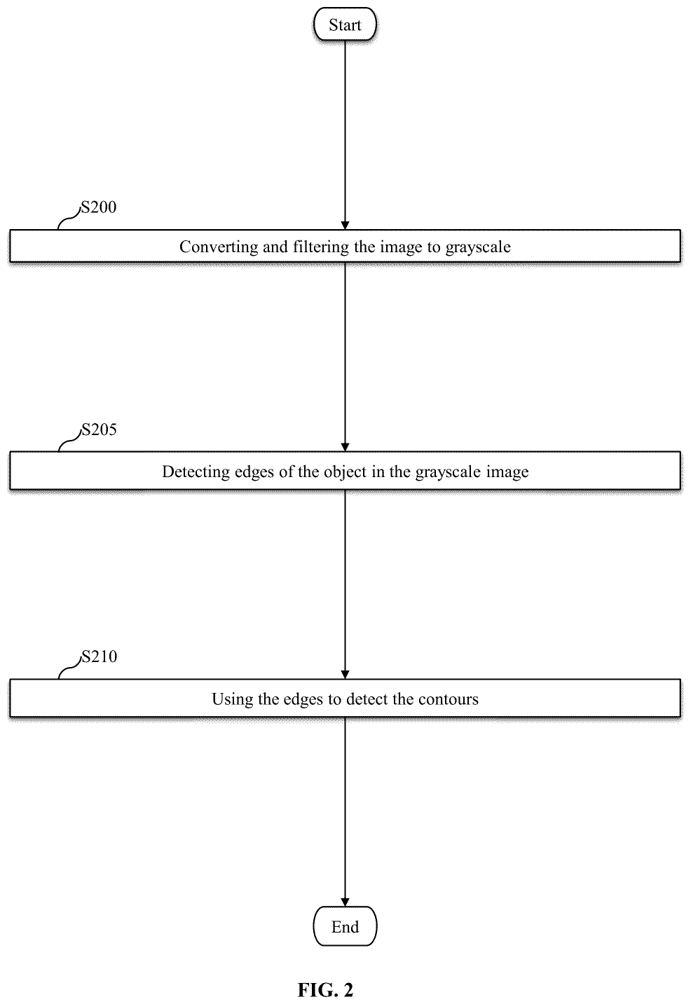

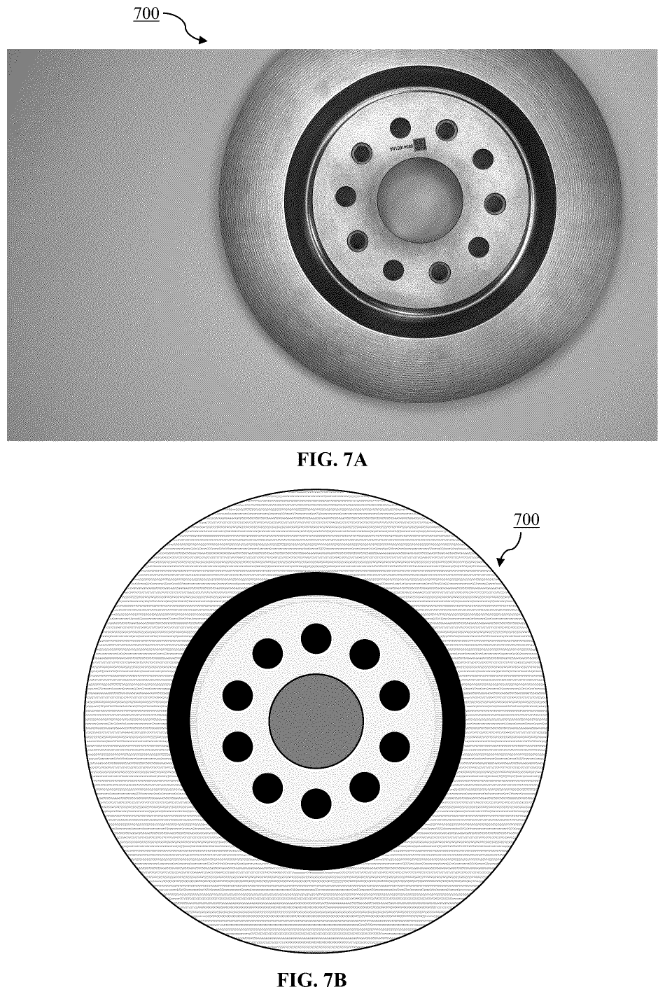

First, in step S100, contours of an object in an image are detected, and the pixel coordinates as well as the hierarchy information of the contours are obtained. The object may be a circular component with circular contours, such as a brake rotor as shown in FIGS. 7-9 by way of example. Details of step S100 will be discussed later below with reference to FIG. 2.

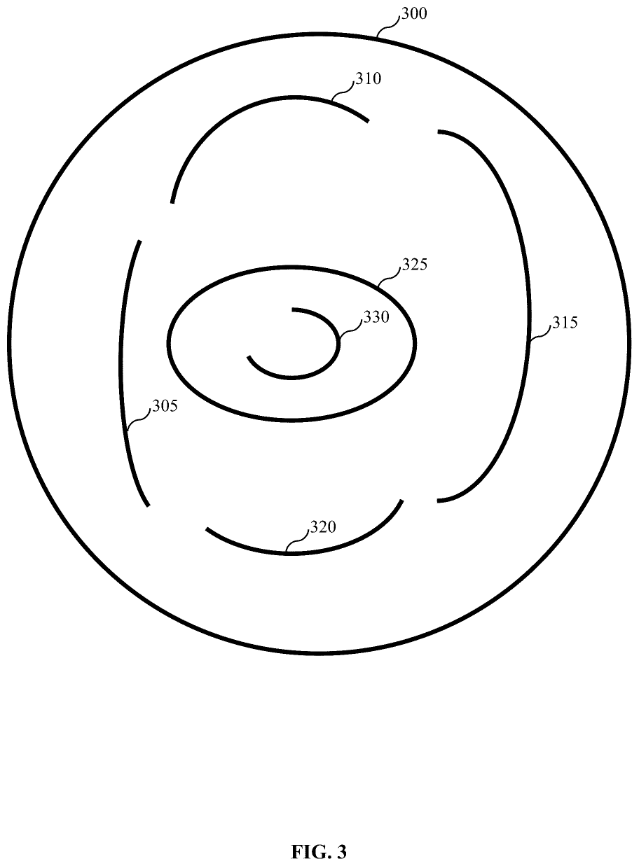

In step S105, the contours of the object in the image are grouped into groups of sibling contours based on the hierarchy information of the contours. Details of step S105 will be discussed later below with reference to FIG. 3.

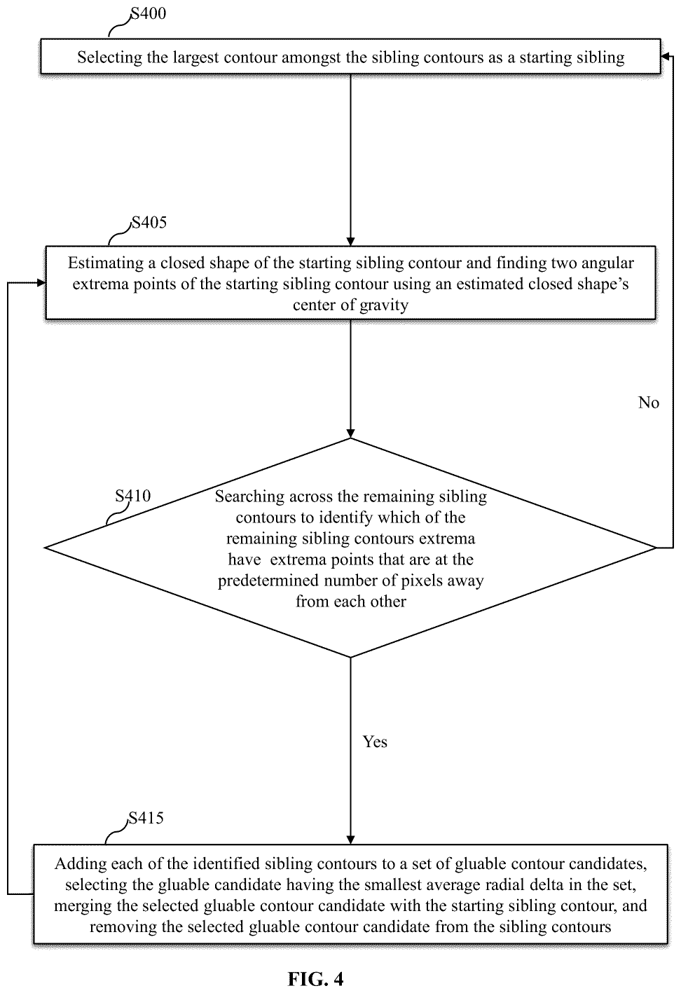

In step S110, adjacent ones of the sibling contours separated by a gap equal to or less than a predetermined number of pixels are mended. Details of step S110 will be discussed later below with reference to FIG. 4.

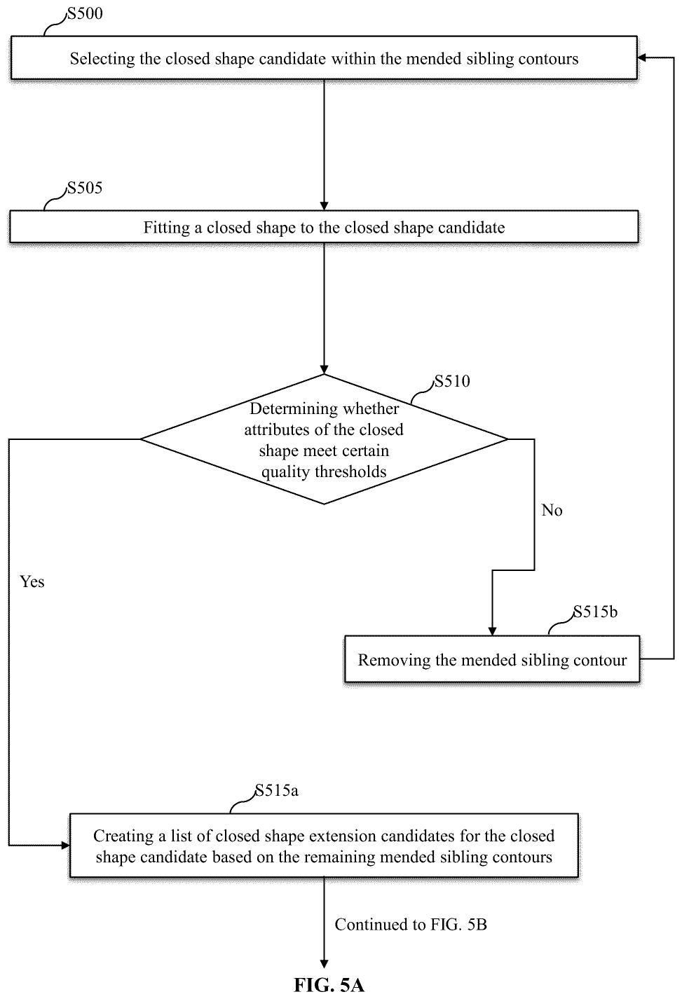

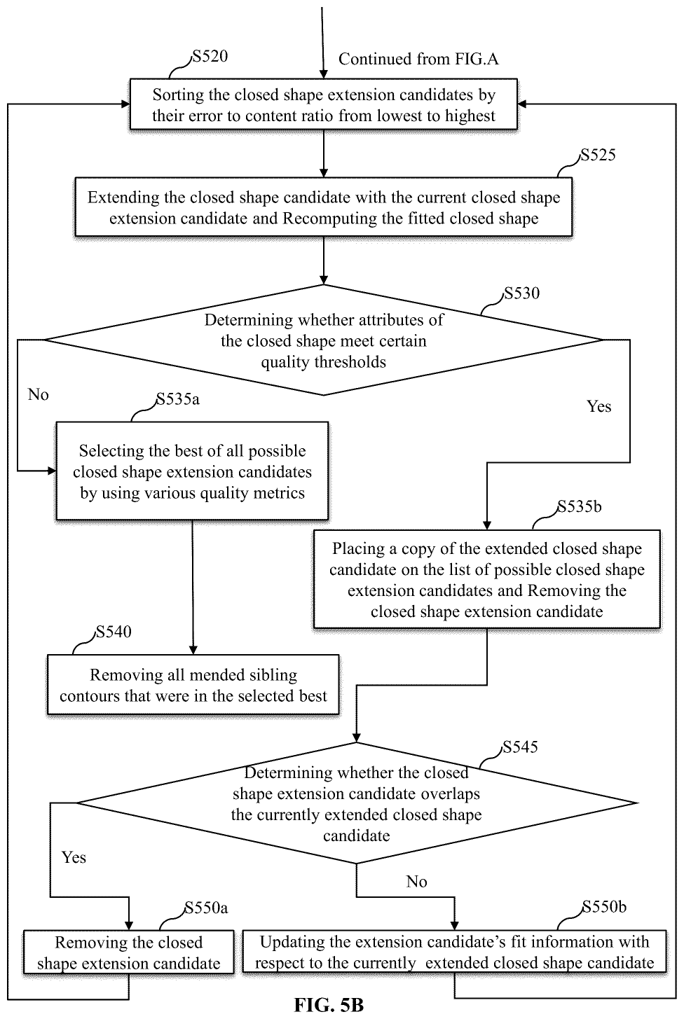

In step S115, a closed shape is fitted to each of the mended sibling contours and each of the mended sibling contours is extended to mirror the closed shape. Details of step S115 will be discussed later below with reference to FIGS. 5A and 5B.

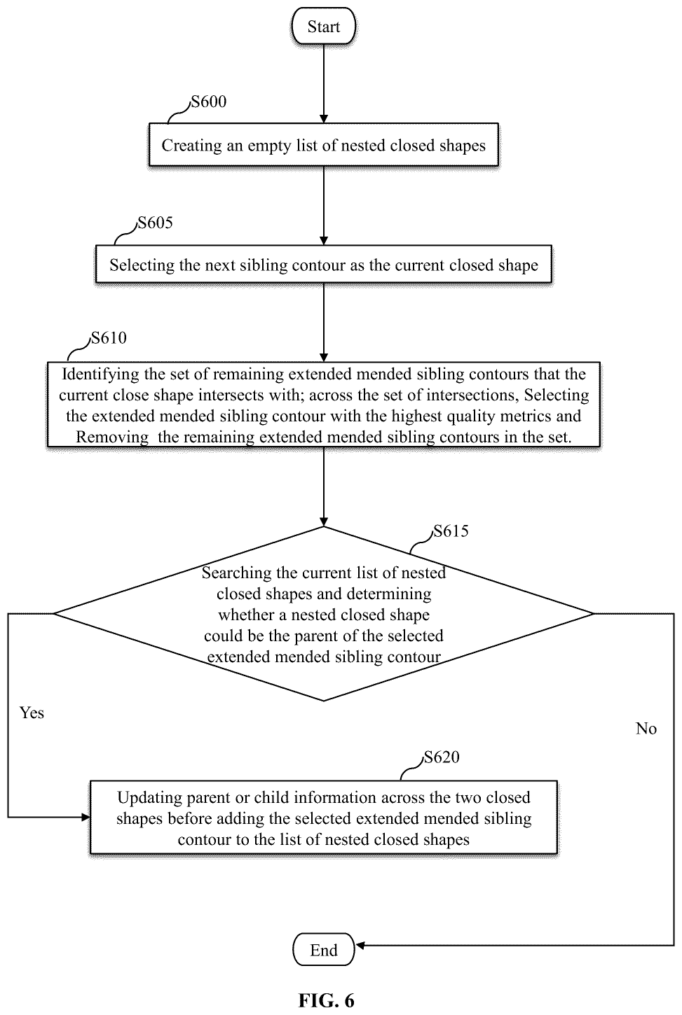

Finally, in step S120, a hierarchy of nested closed shapes is built. Details of step S120 will be discussed later below with reference to FIG. 6.

FIG. 2 shows a flowchart of step S100 of FIG. 1 for detecting contours of an object in an image and obtaining pixel coordinates and hierarchy information of the contours in accordance with one or more embodiments of the invention.

In one or more embodiments, an image of the object must be obtained prior to detecting the contours of the object. The image may be obtained by any means (e.g., downloaded, scanned, captured, imaged, etc.) from any source. For example, the image may be a photograph, a computer-generated image, a scan of a physical image or any other type of image. In one or more embodiments, the image of the object may be imported into Open-Source Computer Vision Library (OpenCV) using its cv.imread( ) function.

First, in step S200, the image of the object is converted to grayscale and filtered. In one or more embodiments, the image may be converted to grayscale using the cv.cvtcolor( ) function of OpenCV. The grayscale image may be smoothed with a bilateral filter using the cv.bilateralFilter( ) function of OpenCV or other methods of image smoothing. Bilateral filtering is highly effective in noise removal while keeping edges sharp.

In step S205, the edges of the object in the image converted into grayscale and smoothed are detected. In one or more embodiments, once the image is converted to grayscale and the grayscale image is smoothed, the edges of the object in the image may be detected using cv.Canny( ) function of OpenCV or other Canny edge detection algorithms. The cv.Canny( ) function incorporates noise reduction (edge detection is susceptible to noise in the image), finding intensity gradient of the image, non-maximum suppression (a full scan of the image is done to remove any unwanted pixels which may not constitute the edges), and hysteresis thresholding (to determine which amongst all edges are really edges and which are not).

Finally, in step S210, the contours of the object are detected. In one or more embodiments, the edges of the object in the image may be used to detect the contours of the object using cv.findContours( ) function of OpenCV. The result of detecting the contours of the object in the image yields a list of pixel coordinates of all contours in the edges image along with hierarchy information about the contours.

FIG. 3 shows an illustration of step S105 of FIG. 1 for grouping the contours into groups of sibling contours based on the hierarchy information. As described herein, in the case of nested shapes, the outer shape is a “parent contour” and any of the inner shapes is a “child contour” of that parent contour (and the child contours of the same parent contour are “sibling contours”). In one or more embodiments, using the hierarchy information, the contours are grouped together such that each contour in a sibling group shares the same parent contour. The grouping of the contours into groups of sibling contours is done as an optimization to reduce the search space for linking broken contours. The sibling contours are sorted by size from the largest contour to the smallest contour. As shown in FIG. 3, for example, contour 300 is in its own sibling group without a parent contour, while contours 305, 310, 315, 320, and 325 are in their own sibling group with the contour 300 as their parent contour. The contour 330 is in its own sibling group with the contour 325 as its parent contour.

FIG. 4 shows a flowchart of step S110 of FIG. 1 for mending adjacent ones of the sibling contours separated by a gap equal to or less than a predetermined number of pixels in accordance with one or more embodiments of the invention. Small gaps may appear in the edges mask, but may be ignored to improve the accuracy in fitting a closed shape to each of the mended sibling contours and in extending each of the mended sibling contours to mirror the closed shape, since a larger mended sibling contour can be obtained for each of the mended sibling contours. A larger mended sibling contour has more pixels to fit, therefore a more accurate estimate of the closed shape. For each of the groups, adjacent ones of the sibling contours separated by a gap equal to or less than a predetermined number of pixels (e.g., 5 pixels) are mended. The predetermined number of pixels may be selected based on the degree of accuracy and the type of application. A lower number of predetermined pixels yields to better accuracy. For each contour in a sibling group, the steps 400, 405, 410, and 415 are performed.

First, in step S400, the largest contour amongst the sibling contours is selected as the “starting sibling contour”. The largest sibling contour has more pixels to fit, therefore a more accurate estimate of the closed shape.

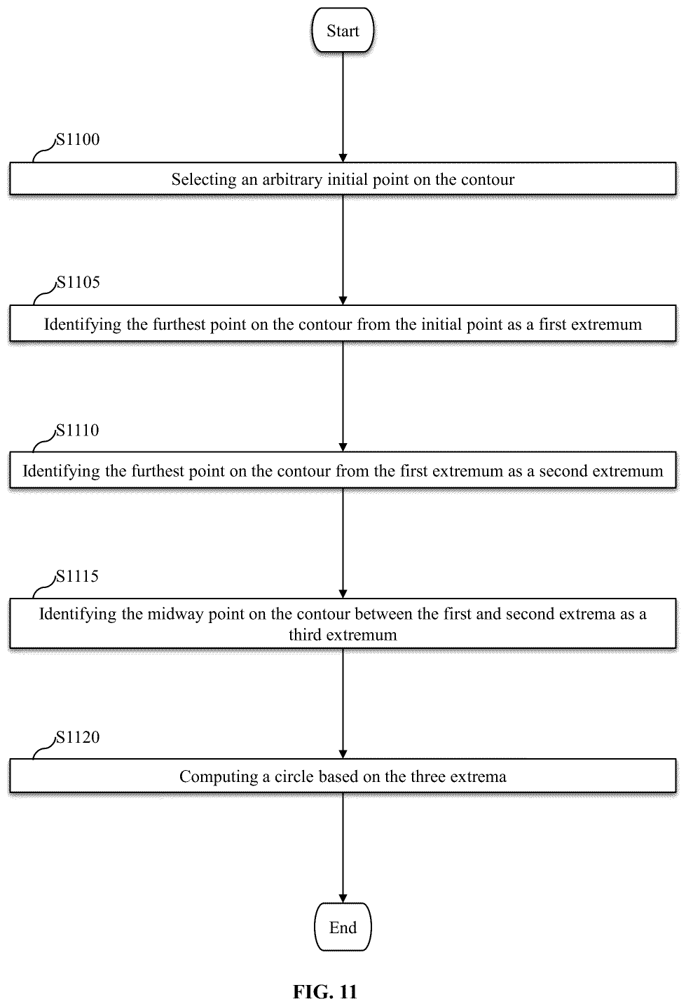

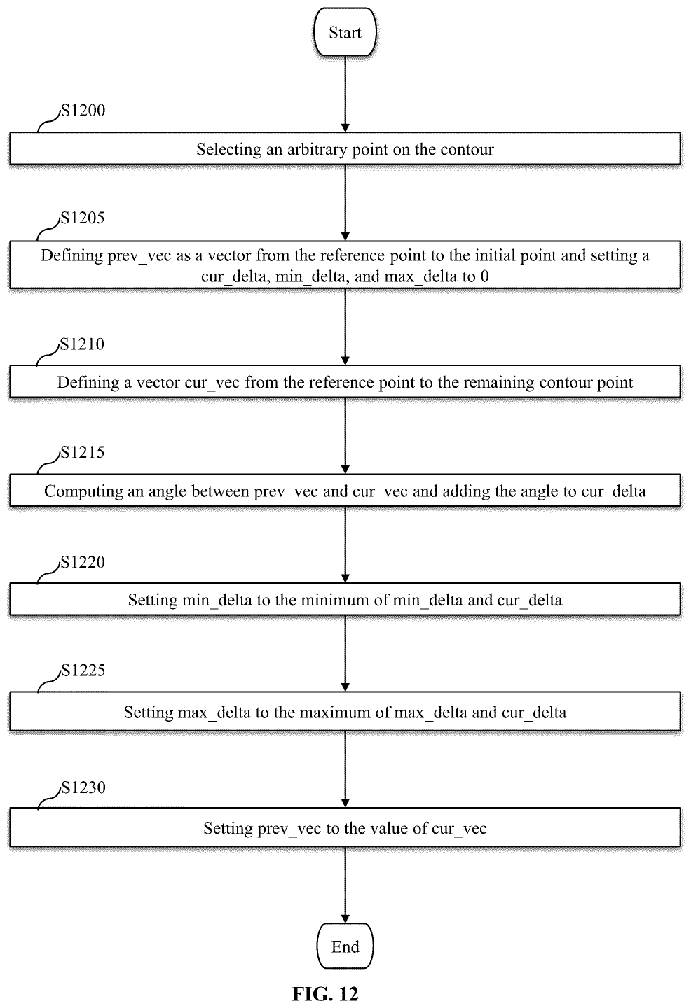

In step S405, a closed shape to the starting sibling contour is estimated and two angular extrema points of the starting sibling contour are found using an estimated center of gravity of the estimated closed shape. Details on how to estimate the closed shape and the two angular points will be described later below with reference to FIGS. 11 and 12.

In step S410, a search is performed across the remaining sibling contours to identify which of the remaining sibling contours extrema have extrema points that are at the predetermined number of pixels away from each other. When one is found, the process continues to step S415. Otherwise, return to step S400.

Finally, in step S415, each one of the identified sibling contours is added to a set of gluable contour candidates. A best gluable contour candidate in the set of gluable contour candidates is selected using one or more criteria. For example, the gluable contour candidate with the smallest average radial delta from the starting sibling contour may be selected as the best gluable candidate. The best gluable contour candidate is merged with the starting sibling contour and removed from the set of sibling contours. The flowchart then returns to step S405.

FIGS. 5A and 5B show a flowchart of step S115 of FIG. 1 for fitting of a closed shape to each of the mended sibling contours and extending of each of the mended sibling contours to mirror the closed shape. The mended sibling contours are sorted by size from the largest to the smallest. Then, for each of the mended sibling contours in each of the sibling groups, the steps of FIGS. 5A and 5B are performed following the sorted order to improve the accuracy in fitting a closed shape to each of the mended sibling contours and in extending each of the mended sibling contours to mirror the closed shape.

First, in step S500, a next mended entry within the mended sibling contours is selected as the “closed shape candidate”.

In step S505, a closed shape is fitted to the closed shape candidate.

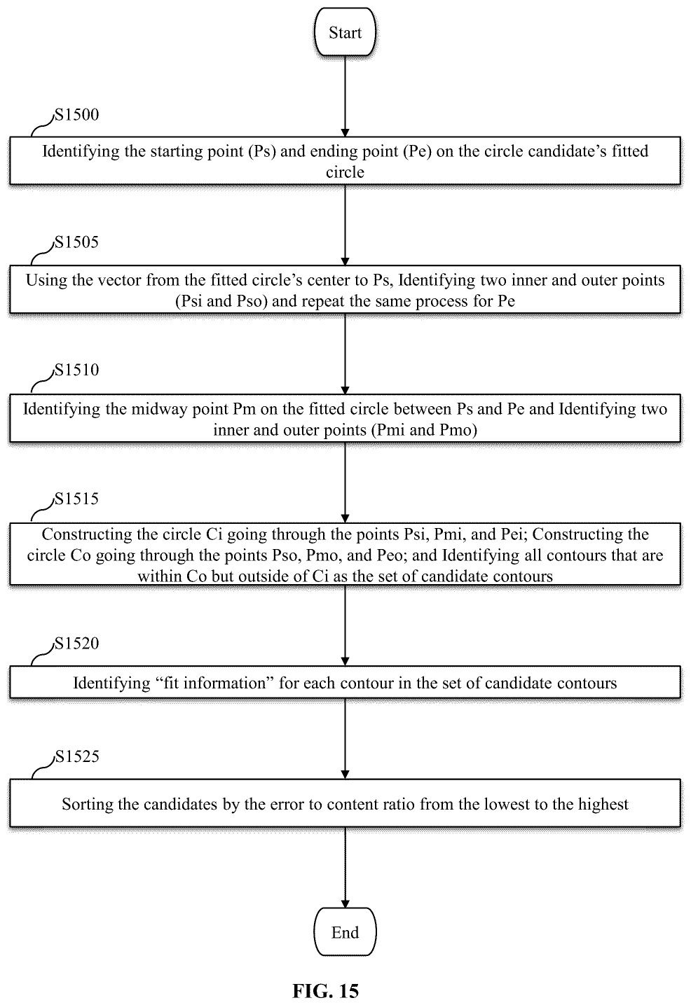

In step S510, if attributes of the closed shape meet certain quality thresholds (e.g., the root mean square error or radius standard deviation are below a user-specified threshold), then continue to step S515a, where a list of all possible closed shape extension candidates is created based on the remaining mended sibling contours. Otherwise, continue to step S515b, where the mended sibling contour is removed, and the flowchart returns to step S500. The process of creating the list of closed shape extension candidates is explained in further detail in FIG. 15. The remaining steps are then repeated for each closed shape extension candidate in the list of closed shape extension candidates.

In step S520, the list of closed shape extension candidates are sorted by the “error to content” ratio, which is the ratio of root mean square error to angular span of the contour relative to the center of gravity of the fitted closed shape, from lowest to highest.

In step S525, the closed shape candidate is extended with the current closed shape extension candidate and the fitted closed shape is recomputed.

In step S530, if quality metrics of the extended closed shape meet certain criteria (see step S510 above), continue to step S535b, where a copy of the extended closed shape candidate is placed on the list of possible closed shape extension candidates and the closed shape extension candidate is removed. Otherwise, continue to step S535a, where the best of all possible closed shape extension candidates is selected by using various quality metrics, such as a weighted average of angular span (bigger is better) and root mean square error (lower is better).

In step S540, all mended sibling contours that were in the selected best of all possible closed shape candidates are removed.

In step S545, for each remaining closed shape extension candidate, if the closed shape extension candidate overlaps the currently extended closed shape candidate by a user-specified threshold, go to step S550a, where the closed shape extension candidate is removed. Otherwise, go to step S550b, where the closed shape extension candidate's fit information (e.g., root mean square error based on the fitted closed shape and the “error to content” ratio) with respect to the currently extended closed shape candidate is updated.

FIG. 6 shows a flowchart of step S120 of FIG. 1 for building of the hierarchy of nested closed shapes in accordance with one or more embodiments of the invention. In one or more embodiments, for each mended sibling contour in the sibling groups, the steps of FIG. 6 are performed as described below.

First, in step S600, an empty list of nested closed shapes is created, where each nested closed shape knows about its parent and children.

In step S605, for each closed shape extended mended sibling contour, the next contour is selected as the current closed shape.

In step S610, for each closed shape extended mended sibling contour, identify the set of remaining closed shape extended mended sibling contours that the current close shape intersects with. Across the set of intersections, select the closed shape extended mended sibling contour with the highest quality metrics (e.g., root mean square error or completeness ratio) and remove the remaining closed shape extended mended sibling contours in the set.

In step S615, search the current list of nested closed shapes to see if a nested close shape could be the parent contour (e.g., completely contains) of the selected extended closed shape mended sibling contour. If so, go to step S620.

In step S620, update parent or child information across the two closed shapes before adding the selected extended closed shape mended sibling contour to the list of nested closed shapes.

The detected nested closed shapes in the image can be used to obtain measurements of various object features for the purposes of inspection. The measurements can be compared against a specification of the object to determine if the object has been cast correctly.

FIG. 7A shows an input image in accordance with one or more embodiments of the invention. FIG. 7B shows an illustration of the input image shown in FIG. 7A. The image 700 as shown is an image of a brake rotor (an example of the object) in accordance with one or more embodiments of the invention. This example identifies the circular feature of the brake rotor for metrology purposes.

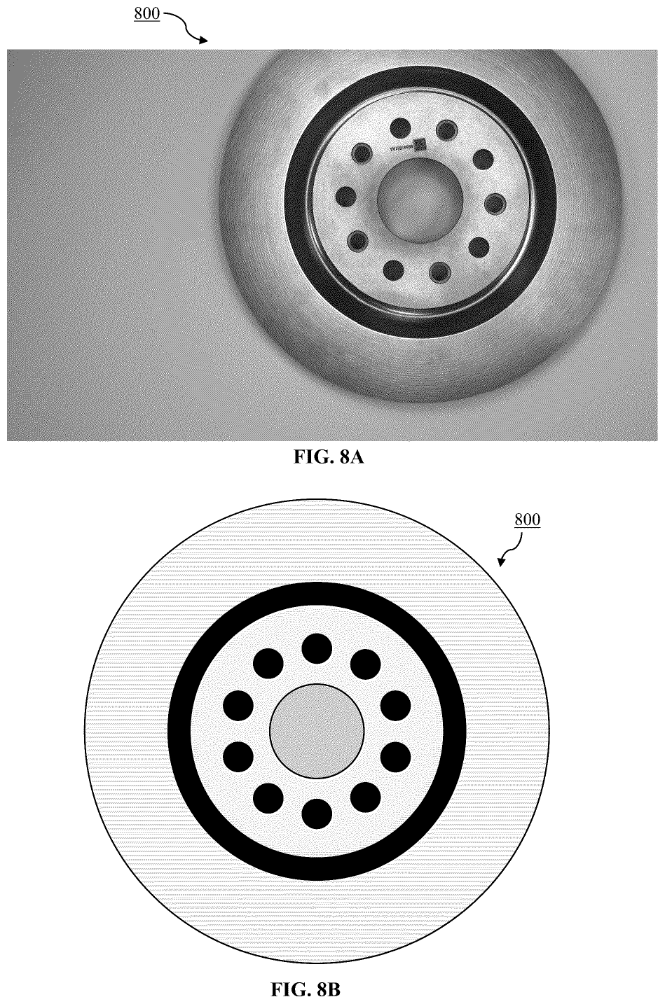

FIG. 8A shows the input image converted to grayscale and filtered in accordance with one or more embodiments of the invention. FIG. 8B shows an illustration of the input image shown in FIG. 8A. The image 800 as shown is a grayscale image of the image 700 which is smoothed.

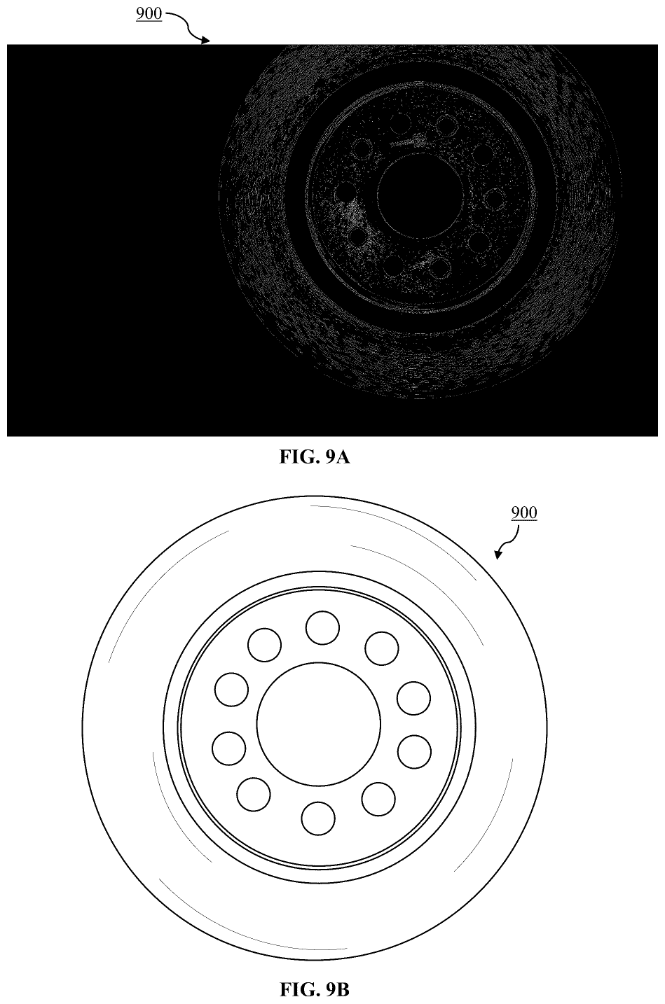

FIG. 9A shows the input image after edges detection was performed on the filtered grayscale image in accordance with one or more embodiments of the invention. FIG. 9B shows an illustration of the input image shown in FIG. 9A. The image 900 as shown is an edged image of the grayscale image 800. The edged image 900 is used to detect the contours of the brake rotor in the image 700.

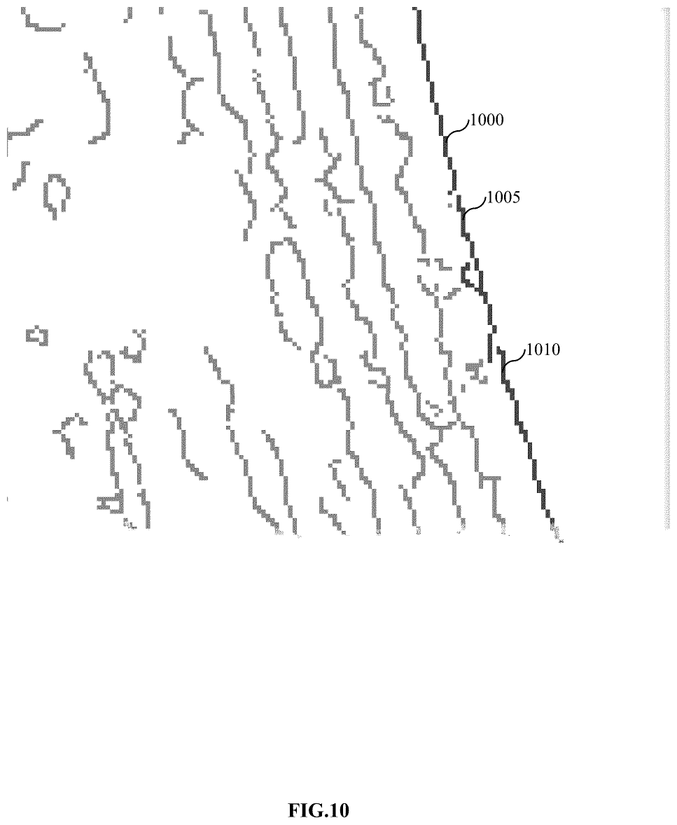

FIG. 10 shows an illustration of a mended sibling contour in accordance with one or more embodiments of the invention. The sibling contour 1000 as shown is a starting sibling contour. The small pixel gap (e.g., less than 5 pixels) between a sibling contour 1005 and the starting sibling contour 1000 is ignored and the sibling contour 1005 is glued onto the starting sibling contour 1000 and removed from the set of sibling contours. Similarly, the sibling contour 1010 is glued onto the starting sibling contour 1000 and removed from the set of sibling contours.

FIG. 11 shows a flowchart for estimating a circle from a contour in accordance with one or more embodiments of the invention. In step S1100, an arbitrary initial point on the contour is selected.

In step S1105, the furthest point on the contour from the initial point is identified as a first extremum.

In step S1110, the furthest point on the contour from the first extremum is identified as a second extremum.

In step S1115, the midway point on the contour between the first and second extrema is identified as a third extremum.

Finally, in step S1120, a circle is then computed based on the three extrema.

FIG. 12 shows a flowchart for finding two angular extrema points of a contour relative to the center of the estimated circle. In one or more embodiments, to find the two angular extrema points of a contour relative to a reference point (e.g., the center of an estimated circle) the steps of FIG. 12 are performed as described below.

In step S1200, an arbitrary initial point on the contour is selected.

In step S1205, a vector prev_vec is defined from the reference point to the initial point and a cur_delta, min_delta, and max_delta are set to 0. The following steps are then performed for each remaining point of the contour.

In step S1210, a vector cur_vec is defined from the reference point to the remaining contour point.

In step S1215, the angle between prev_vec and cur_vec is computed and added to cur_delta.

In step S1220, min_delta is set to the minimum of min_delta and cur_delta.

In step S1225, max_delta is set to the maximum of max_delta and cur_delta

Finally, in step S1230, prev_vec is set to the value of cur_vec. At the end of iterating over the points of the contour, the angular extrema points correspond to the points with min_delta and max_delta.

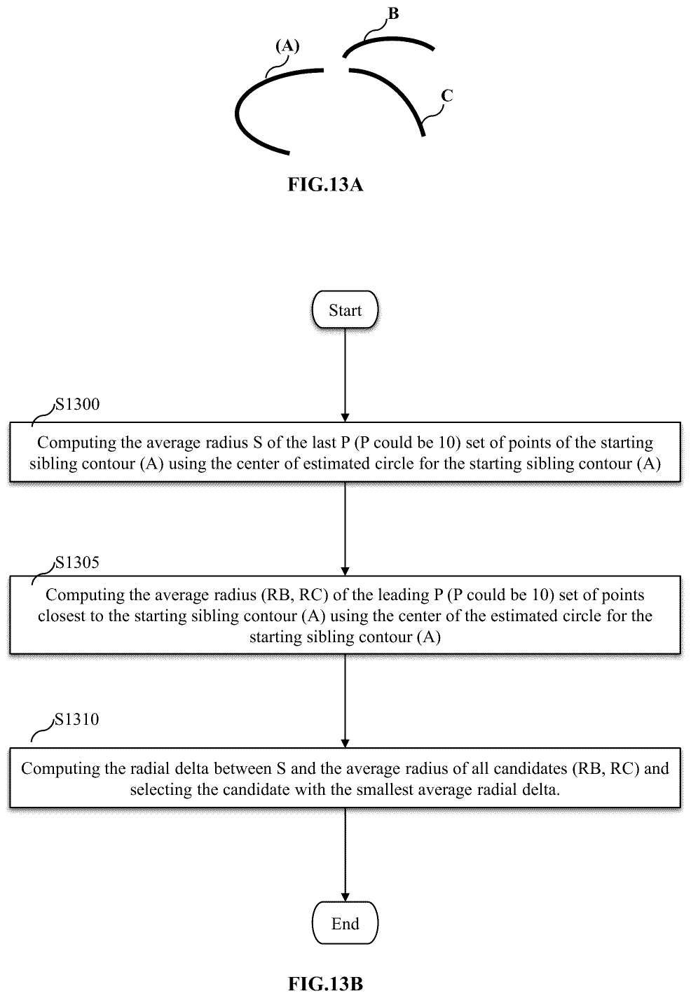

FIG. 13A shows an illustration of sibling contours and FIG. 13B shows a flowchart for selecting the best gluable candidate among the sibling contours shown in FIG. 13A in accordance with one or more embodiments of the invention.

As shown in FIG. 13A, there may be more than one gluable candidate for a starting sibling contour. Both gluable candidates B and C are sufficiently close to the end of starting sibling contour A.

In one or more embodiments, to select the best gluable candidate, the steps of FIG. 13B are performed as described below.

First, in step S1300, the average radius S of the last P (P could be 10) set of points of the starting sibling contour (A) are computed using the center of the estimated circle for the starting sibling contour (A).

In step S1305, for all candidates (B and C), the average radius (R_{B}, R_{C}) of the leading P (P could be 10) set of points closest to the starting sibling contour (A) are computed using the center of the estimated circle for the starting sibling contour (A).

Finally, in step S1310, the radial delta between S and the average radius of all candidates (R_{B}, R_{C}) are computed and the candidate with the smallest average radial delta is selected.

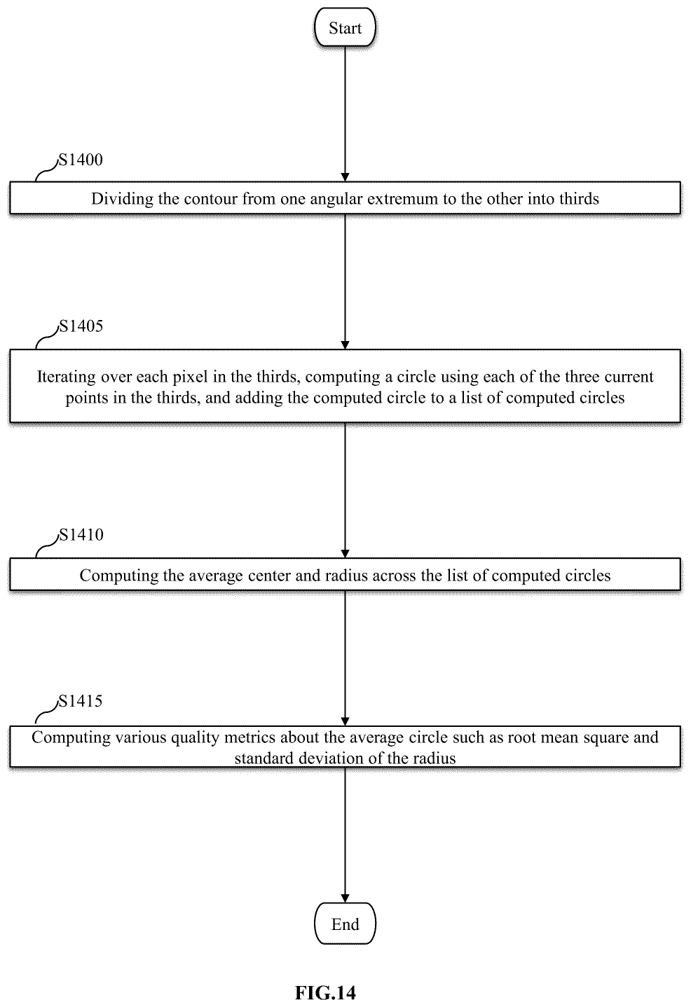

FIG. 14 shows a flowchart for fitting a circle to a circle candidate in accordance with one or more embodiments of the invention.

First, in step S1400, the contour is divided from one angular extremum to the other into thirds.

In step S1405, iterating over each pixel in the thirds, compute a circle using each of the three current points in the thirds. Add the computed circle to a list of computed circles.

In step S1410, compute the average center and radius across the list of computed circles.

In optional step S1415, compute various quality metrics about the average circle, such as root mean square error and the standard deviation of the radius/center.

FIG. 15 shows a flowchart for creating a list of extension candidate in accordance with one or more embodiments of the invention.

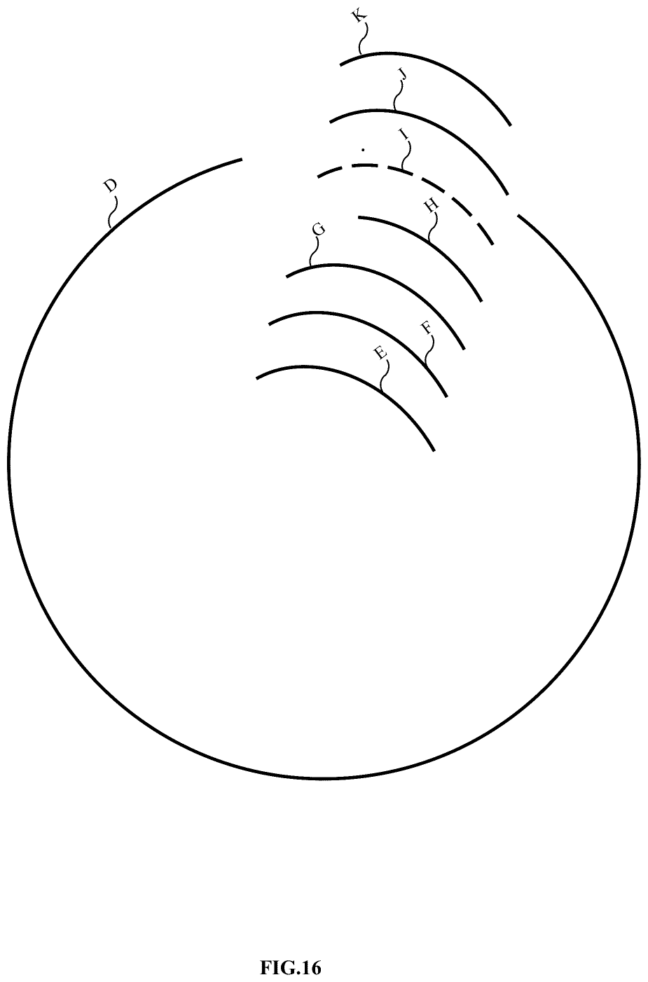

A scenario that requires the creation for a list of extension candidate is illustrated in FIG. 16, where contour D has been identified as the circle candidate. It would be advantageous to see if contour D can be merged with any other contours E, F, G, H, I, J, and K to form as complete a circle as possible.

Returning to FIG. 15, in one or more embodiments, the process for creating a list of extension candidates are performed as described below.

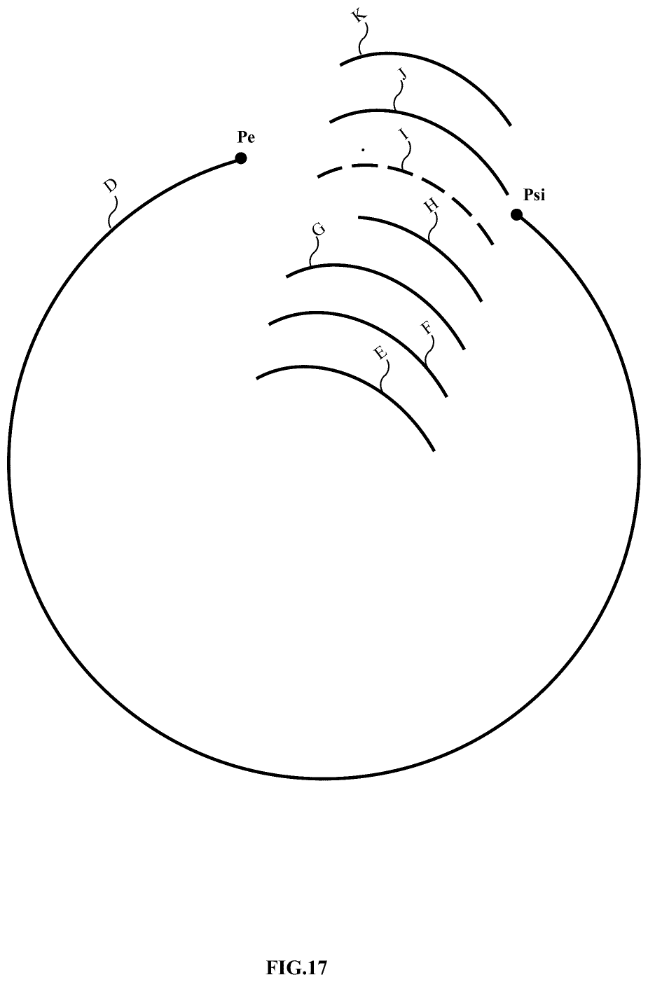

First, in step S1500, a starting point (Ps) and an ending point (Pe) on the circle candidate's fitted circle are identified based on the circle candidate's angular extrema as shown in FIG. 17.

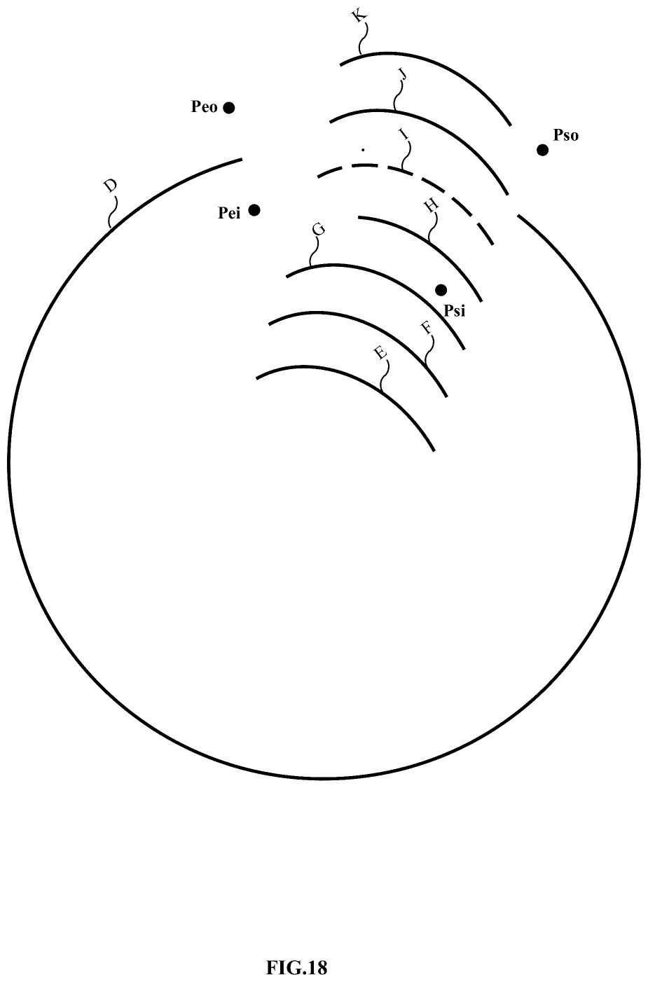

In step S1505, using the vector from the fitted circle's center to Ps, identify two inner and outer points (Psi and Pso) that are translated a small amount (e.g., 2% of the radius) in a positive and negative direction along that vector as shown in FIG. 18. Repeat the same process for Pe.

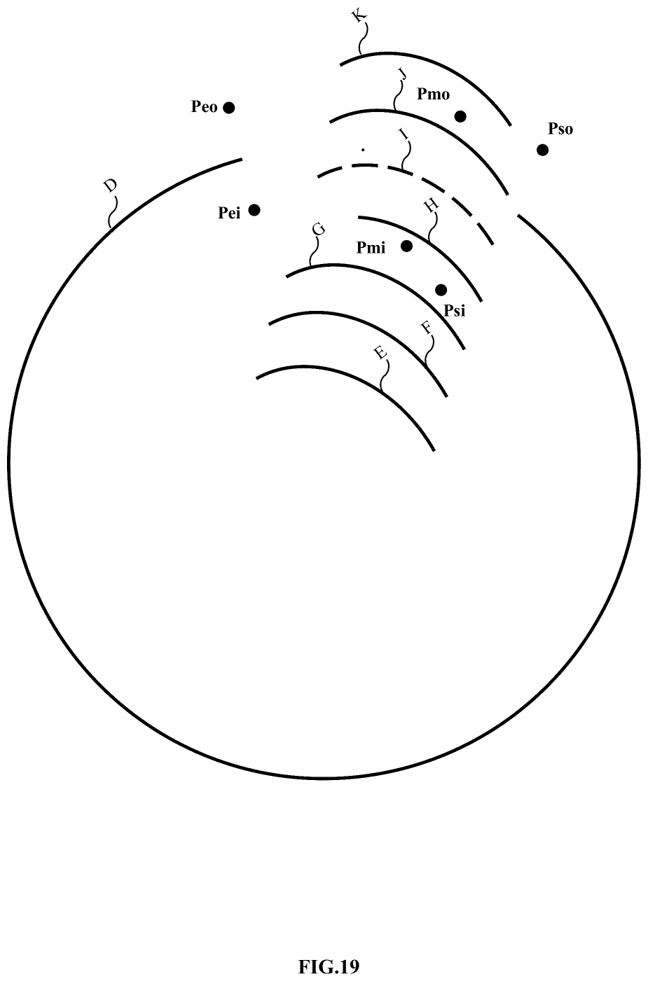

In step S1510, identify the midway point Pm on the fitted circle between Ps and Pe. Similar as to before, identify an inner and outer point (Pmi and Pmo), as shown in FIG. 19 that is negatively/positively translated by a larger amount (e.g., 5% the radius) along the vector from the circle's center to Pm.

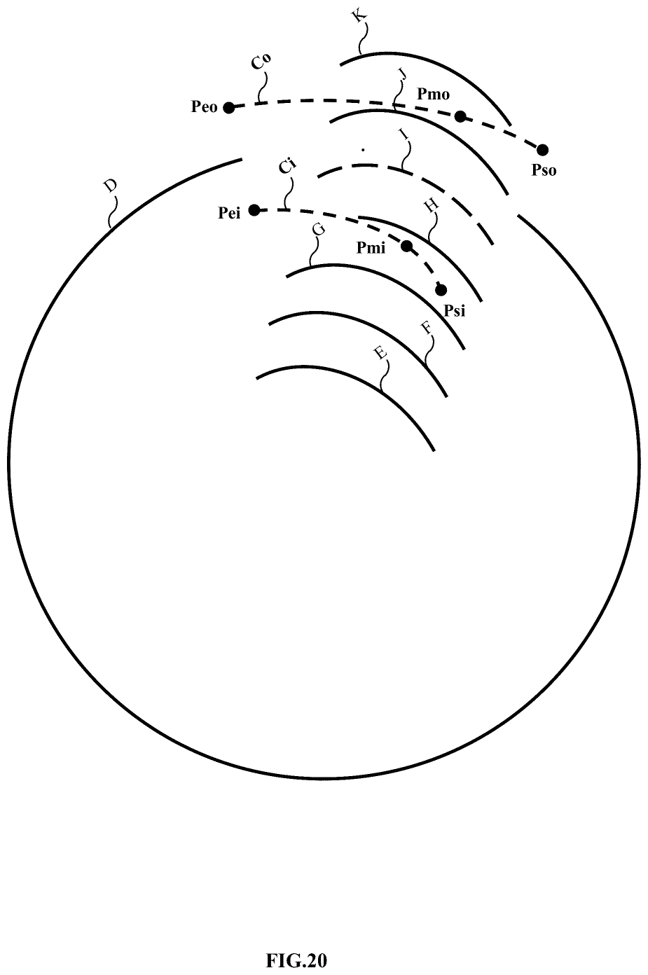

In step S1515, construct the circle Ci going through the points Psi, Pmi, and Pei as shown in FIG. 20. Construct the circle Co going through the points Pso, Pmo, and Peo. Identify all contours that are within Co but outside of Ci as the set of candidate contours. This yields the set of contours H, I, and J.

In step S1520, for each contour in the set of candidate contours, identify “fit information” for the contour, which includes root mean square error based on the fitted circle and an “error to content” ratio, which is the ratio of root mean square error to angular span of the contour relative to the fitted circle's center.

Finally, in step S1525, sort the candidates by the error to content ratio from the lowest to the highest.

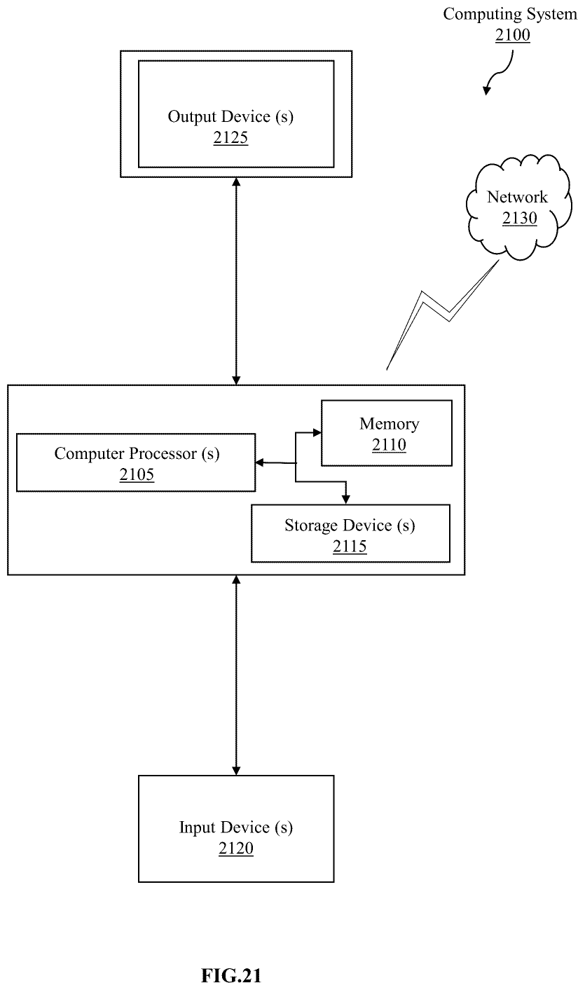

FIG. 21 shows a computing system for implementing the above-described method in accordance with one or more embodiments of the invention.

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 21, the computing system (2100) may include one or more computer processor(s) (2105), associated memory (2110) (e.g., random access memory (RAM), cache memory, flash memory, etc.), one or more storage device(s) (2115) (e.g., a hard disk, an optical drive such as a compact disk (CD) drive or digital versatile disk (DVD) drive, a flash memory stick, etc.), and numerous other elements and functionalities. The computer processor(s) (2105) may be an integrated circuit for processing instructions of the method in accordance with one or more embodiments. For example, the computer processor(s) may be one or more cores, or micro-cores of a processor. The computing system (2100) may also include one or more input device(s) (2120), such as a touchscreen, keyboard, mouse, microphone, touchpad, electronic pen, or any other type of input device. Further, the computing system (2100) may include one or more output device(s) (2125), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (2100) may be connected to a network (2130) (e.g., a local area network (LAN), a wide area network (WAN) such as the Internet, mobile network, or any other type of network) via a network interface connection (not shown). The input and output device(s) may be locally or remotely (e.g., via the network (2130)) connected to the computer processor(s) (2105), memory (2110), and storage device(s) (2115). Many different types of computing systems exist, and the aforementioned input and output device(s) may take other forms.

Software instructions in the form of computer readable instructions to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable instructions that when executed by a processor(s), is configured to perform embodiments of the invention.

Further, one or more elements of the aforementioned computing system (2100) may be located at a remote location and be connected to the other elements over a network (2130). Further, one or more embodiments of the invention may be implemented on a distributed system having a plurality of nodes, where each portion of the invention may be located on a different node within the distributed system. In one or more embodiments, the node corresponds to a distinct computing device. Alternatively, the node may correspond to a computer processor with associated physical memory. The node may alternatively correspond to a computer processor or micro-core of a computer processor with shared memory and/or resources.

One or more of the embodiments of the invention may have one or more of the following advantages and improvements over conventional techniques for the detection of closed shapes such as circles, ellipses, etc., within an image: improving the efficacy and accuracy with which nested closed shapes can be detected from natural images, photographs, computer-generated images, or any type of electronic image; and accelerating the time for processing data. The above advantages may improve a user's ability to obtain measurements of various object features for the purposes of inspection. For example, the obtained measurements can be compared against a specification of the object to determine if the object has been cast correctly.

Although the disclosure has been described with respect to a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A nested closed shapes detection method, comprising:
detecting contours of an object in an image and obtaining pixel coordinates and hierarchy information of the contours;
grouping, based on the hierarchy information, the contours into groups of sibling contours;
for each of the groups, mending adjacent ones of the sibling contours separated by a gap equal to or less than a predetermined number of pixels;
fitting a closed shape to each of the mended sibling contours and extending each of the mended sibling contours to mirror the closed shape; and
building a hierarchy of nested closed shapes.

2. The method of claim 1, wherein the predetermined number of pixels is five.

3. The method of claim 1, wherein the detecting of the contours of the object comprises:
converting and filtering the image to grayscale;
detecting edges of the object in the grayscale image; and
using the edges to detect the contours.

4. The method of claim 1, wherein the grouping of the contours comprises:
sorting the sibling contours by size from largest to smallest.

5. The method of claim 1, wherein the mending of the adjacent sibling contours comprises iterative steps of:
selecting the largest contour amongst the sibling contours as a starting sibling contour;
estimating a closed shape of the starting sibling contour;
identifying two angular extrema points of the starting sibling contour based on a center of gravity of the estimated closed shape;
searching across the remaining sibling contours to identify which of the remaining sibling contours have extrema points that are at the predetermined number of pixels away from each other, then adding each one of the identified sibling contours to a set of gluable contour candidates;
selecting, from the set of gluable contour candidates, the gluable candidate having the smallest average radial delta in the set, and merging the selected gluable contour candidate with the starting sibling contour; and
removing the selected gluable contour candidate from the sibling contours.

6. The method of claim 1, wherein
the fitting of the closed shape to each of the mended sibling contours comprises:
selecting a closed shape candidate within the mended sibling contours;
fitting the closed shape to the closed shape candidate; and
determining whether attributes of the closed shape, including at least root mean square error and standard deviation, are below a user-specified threshold, and then creating a list of closed shape extension candidates for the closed shape candidate based on the remaining mended sibling contours, and
the extending of each of the mended sibling contours to mirror the closed shape comprises, for each of the closed shape extension candidates:
extending the closed shape candidate with the closed shape extension candidate and recomputing the closed shape;
determining whether the attributes of the extended closed shape are below a user-specified threshold, then placing a copy of the extension closed shape candidate on the list of closed shape extension candidates and removing the extension closed shape candidate; and
sorting the extension closed shape candidates by their error to content ratio from lowest to highest.

7. The method of claim 6, wherein the method further comprises:
in a case where the attributes of the extended closed shape are above the user-specified threshold:
selecting, from the closed shape extension candidates, the closed shape extension candidate having the biggest weighted average of angular span and the lowest root mean square error; and
removing all the mended sibling contours that were among the closed shape extension candidates.

8. The method of claim 1, wherein the building of the hierarchy of nested closed shapes comprises, for each one of the extended mended sibling contours:
selecting an extended mended sibling contour as a current closed shape;
identifying a set of the remaining extended mended sibling contours that the current closed shape intersects;
selecting the extended mended sibling contour with the lowest root mean square error or highest completeness ratio in the set and removing the remaining extended mended sibling contours in the set;
searching a current list of nested closed shapes to verify that a nested closed shape could be completely contained by the selected extended mended sibling contour; and
updating parent or child information across the two closed shapes before adding the selected extended mended sibling contour to the list of nested closed shapes.

9. A non-transitory computer readable medium (CRM) storing computer readable instructions for nested closed shapes detection in an image, the computer readable instructions causing a computer to:
detect contours of an object in an image and obtain pixel coordinates and hierarchy information of the contours;
group, based on the hierarchy information, the contours into groups of sibling contours;
for each of the groups, mend adjacent ones of the sibling contours separated by a gap equal to or less than a predetermined number of pixels;
fit a closed shape to each of the mended sibling contours and extend each of the mended sibling contours to mirror the closed shape; and
build a hierarchy of nested closed shapes.

10. The non-transitory CRM of claim 9, wherein the predetermined number of pixels is five.

11. The non-transitory CRM of claim 9, wherein the detecting of the contours of the object comprises:
converting and filtering the image to grayscale;
detecting edges of the object in the grayscale image; and
using the edges to detect the contours.

12. The non-transitory CRM of claim 9, wherein the grouping of the contours comprises:
sorting the sibling contours by size from largest to smallest.

13. The non-transitory CRM of claim 9, wherein the mending of the adjacent sibling contours comprises iterative steps of:
selecting the largest contour amongst the sibling contours as a starting sibling contour;
estimating a closed shape of the starting sibling contour;
identifying two angular extrema points of the starting sibling contour based on a center of gravity of the estimated closed shape;
searching across the remaining sibling contours to identify which of the remaining sibling contours have extrema points that are at the predetermined number of pixels away from each other, then adding each one of the identified sibling contours to a set of gluable contour candidates;
selecting, from the set of gluable contour candidates, the gluable candidate having the smallest average radial delta in the set, and merging the selected gluable contour candidate with the starting sibling contour; and
removing the selected gluable contour candidate from the sibling contours.

14. The non-transitory CRM of claim 9, wherein
the fitting of the closed shape to each of the mended sibling contours comprises:
selecting a closed shape candidate within the mended sibling contours;
fitting the closed shape to the closed shape candidate; and
determining whether attributes of the closed shape, including at least root mean square error and standard deviation, are below a user-specified threshold, and then creating a list of closed shape extension candidates for the closed shape candidate based on the remaining mended sibling contours, and
the extending of each of the mended sibling contours to mirror the closed shape comprises, for each of the closed shape extension candidates:
extending the closed shape candidate with the closed shape extension candidate and recomputing the closed shape;
determining whether the attributes of the extended closed shape are below the user-specified threshold, then placing a copy of the extension closed shape candidate on the list of possible extension closed shape candidates and removing the extension closed shape candidate; and
sorting the extension closed shape candidates by their error to content ratio from lowest to highest.

15. The non-transitory CRM of claim 14, wherein the method further comprises:
in a case where the attributes of the extended closed shape are above the user-specified threshold:
selecting, from the closed shape extension candidates, the closed shape extension candidate having the biggest weighted average of angular span and the lowest root mean square error; and
removing all the mended sibling contours that were among the closed shape extension candidates.

16. The non-transitory CRM of claim 9, wherein the building of the hierarchy of nested closed shapes comprises, for each one of the extended mended sibling contours:
selecting an extended mended sibling contour as a current closed shape;
identifying a set of the remaining extended mended sibling contours that the current closed shape intersects;
selecting the extended mended sibling contour with the lowest root mean square error or highest completeness ratio in the set and removing the remaining extended mended sibling contours in the set;
searching a current list of nested closed shapes to verify that a nested closed shape could be completely contained by the selected extended mended sibling contour; and
updating parent or child information across the two closed shapes before adding the selected extended mended sibling contour to the list of nested closed shapes.
